(19) United States
(12) Patent Application Publication
(10) Pub. No.: US 2002/0119012 A1
(43) Pub. Date: Aug. 29, 2002

(54) Method of constructing pipelines in shallow ice covered waters

(76) Inventor: Patrick Agnew, Calgary (CA)

Correspondence Address: Ilya Zborovsky, 6 Schoolhouse Way, Dix Hills, NY, 11746, US

(21) Appl. No.: 09/793,555

(22) Filed: Feb. 27, 2001

(51) Int. Cl. F16L 1/00

(52) U.S. Cl. 405/158; 405/217

(57) ABSTRACT

A method of constructing pipelines in shallow ice covered waters includes freezing a long narrow pipeline workway so as to thicken ice until an ice mass grounds to an ocean floor, and removing ice in the ice mass to create a construction work area for laying a pipeline.

### BACKGROUND OF THE INVENTION

The present invention relates to a method of constructing pipelines in shallow ice covering waters.

With the growing demand for natural gas as the preferred hydrocarbon fuel, the oil and gas industry is again looking into the frontier for new supplies. The need to lay gathering and transmission pipelines offshore in Northern and Arctic waters will be necessary to complete new projects. A pipeline from Prudhoe Bay to the Mackenzie Delta is currently under consideration. Pipelines extending out into the shallow Mackenzie Delta water will also soon be required.

All pipelines which are built in ice covered waters will have to be buried to avoid ice scour damage, except those pipelines which are below ice scour depth. Many methods have been considered for constructing pipelines in the North. Each method will have its advantages and disadvantages. Conventional lay barges can lay pipelines in moderate to extremely deep waters during the short ice-free period; however; this method is expensive and risky due to the unpredictable ice-free season. Laying a pipeline into a dredged or ditched trench is feasible but complicates the process. U.S. Pat. No. 4,710,059 teaches a method of trenching and laying a pipeline from the ice surface. This method is designed for moderately deep waters. Other methods of trenching and laying pipeline through a slot in the ice have been proposed for both deep and moderately deep water.

Any method which requires mobilization of major equipment such as lay barges or the creation of new and unproven construction equipment will be extremely expensive to employ. Any method which require trenching in the ocean floor during ice-free or ice-covered conditions will be environmentally harmful due to siltation migration and interference with fish and mammal activities. What is needed is a pipeline construction method which is inexpensive to employ and puts a minimal impact on the environment.

### SUMMARY OF THE INVENTION

Accordingly, it is an object of the present invention to provide a method of constructing pipelines in shallow ice covered waters, which avoids the disadvantages of the prior art.

In keeping with these objects and with others which will become apparent hereinafter, one feature of present invention resides, briefly stated, in a method of constructing pipelines in shallow ice covered waters which includes freezing a long narrow pipeline workway so as to thicken ice until an ice mass grounds to an ocean floor; and removing ice in the ice mass to create a construction work area for laying a pipeline.

In accordance with another feature of present invention, said freezing includes multiple flooding and freezing of a long narrow pipeline workway, to thicken the ice.

In accordance with still a further feature of the present invention, when the sea bottom material consists of a suitably strong material, said removing includes forming a trench through the ice mass and downwardly below the ocean floor.

When the sea bottom material consists of poor ditching material, said ditching includes removing a width of ice, exposing the sea bottom in a region corresponding to the ditch, freezing the thusly exposed region of the sea bottom, and forming a further ditch in the thusly frozen region of the sea bottom.

The novel features which are considered as characteristic for the present invention are set forth in particular in the appended claims. The invention itself, however, both as to its construction and its method of operation, together with additional objectives and advantages thereof, will be best understood from the following description of specific embodiments when read in connection with the accompanying drawings.

### BRIEF DESCRIPTION OF THE DRAWINGS

FIGS. 1a and 1b are an elevation view and a plan view illustrating an initial phase of a method in accordance with the present invention;

FIG. 2 is a view showing an elevation view corresponding to the view of FIG. 1, but illustrating a further step of the inventive method for the use in the cases when the sea bottom consists of a strong or competent material;

FIGS. 3a and 3b are views showing two embodiments of another modification of the method for the case when the sea bottom consists of a poor ditching material;

FIG. 4 is a view schematically showing the process of laying a pipeline in accordance with the inventive method.

### DESCRIPTION OF PREFERRED EMBODIMENTS

In accordance with the present invention, a pipeline is constructed in shallow ice-covered waters (e.i. less than 25 feet for example), wherein ambient conditions dictate a significant portion of the year to be ice covered. The invention is particularly suited to pipelines which extend parallel to a shoreline or a pipeline which extends outward from a shoreline traversing a region of relatively shallow water which will be common in the Mackenzie Delta region or Beaufort Sea.

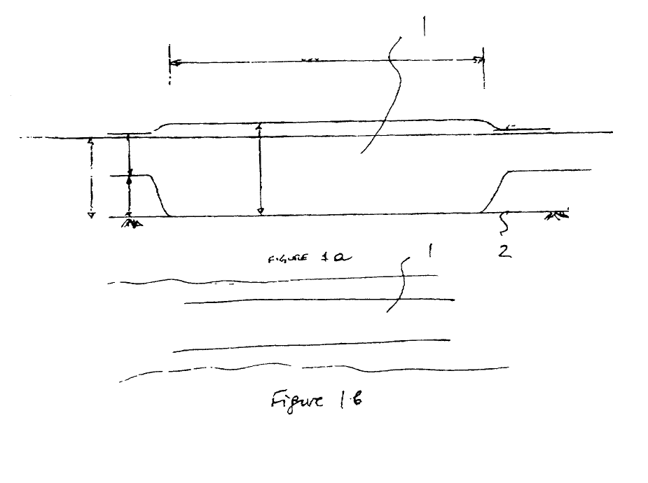

In accordance with the present invention, in an initial phase, a multiple flooding and freezing of a long narrow pipeline workway is performed, which will result in a thickening of the buoyant ice cover. The flooding can commence in the fall once two feet or three feet of natural ice has developed. After a sufficient flooding and freezing the ice mass 1 will ground itself to the ocean floor completing the grounding phase of the work. Ice buildup and depth to the sea floor is carefully monitored until ice contacts the sea floor. Once contact is made, additional ice is prepared to create a substantial extra mass which will ensure no movement of the structure and to reduce water migration from the sea into the ditch. This stage is illustrated in FIGS. 1a and 1b.

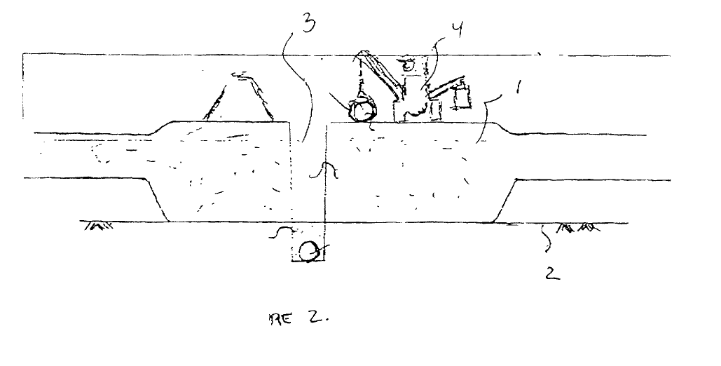

In the next stage ice is removed from the pipeline workway to create an appropriate construction work area. For a sea bottom which consists of a strong material, a ditch 3 is made, for example by an excavator 4 as shown in FIG. 2. The excavator forms a ditch from the top of ice to the required bottom of ditch which will result in the required depth of cover below the sea floor.

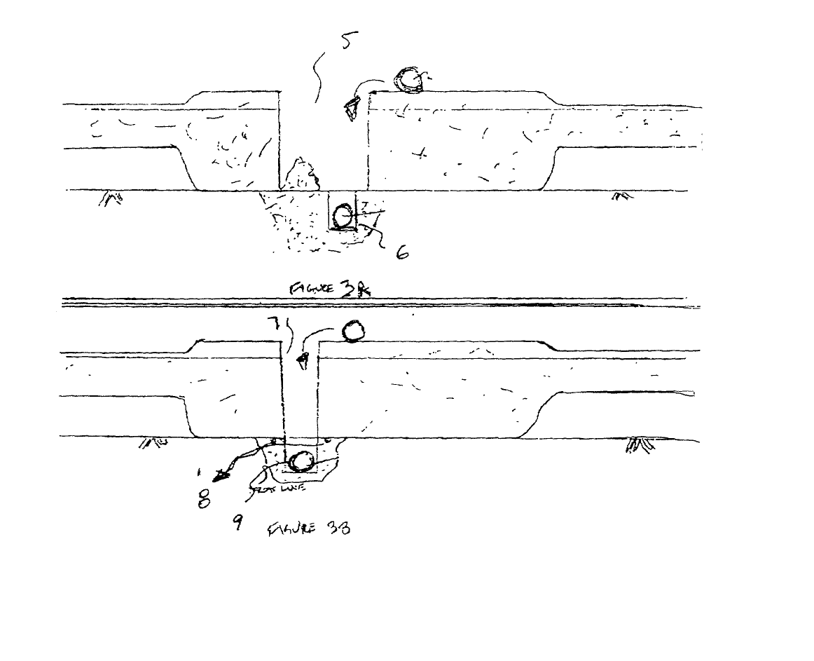

If the sea bottom consists of a poor ditching material, such that sea bed slumping during trenching or sea water migration through the sea bed into an open trench is possible, it is necessary to freeze the sea bed to a depth below the ditch bottom in the vicinity of the trench. In accordance with one embodiment of the invention, as shown in FIG. 3a, ice is removed in a wide area 5 down to the sea bed, and then the sea bottom is frozen, for example by ambient air to create the required frost penetration. Air movers can be used to accelerate the process. When the corresponding region of the sea bed is frozen, a further ditch 6 is formed below the sea bed floor.

In accordance with another embodiment of the present invention, as shown in FIG. 3b, the ditch 7 can be made by employing one or more small diameter pipes 8 which are laid on the sea floor along the alignment of the trench. Once flooding is substantially complete, a non-pollutant pollutant refrigerant such a liquid air or nitrogen can be injected into the pipes 8 to artificially promote the required frost penetration. Again, when the region below the ditch 9 is frozen, then the ditch is formed from the top of ice to the required ditch level.

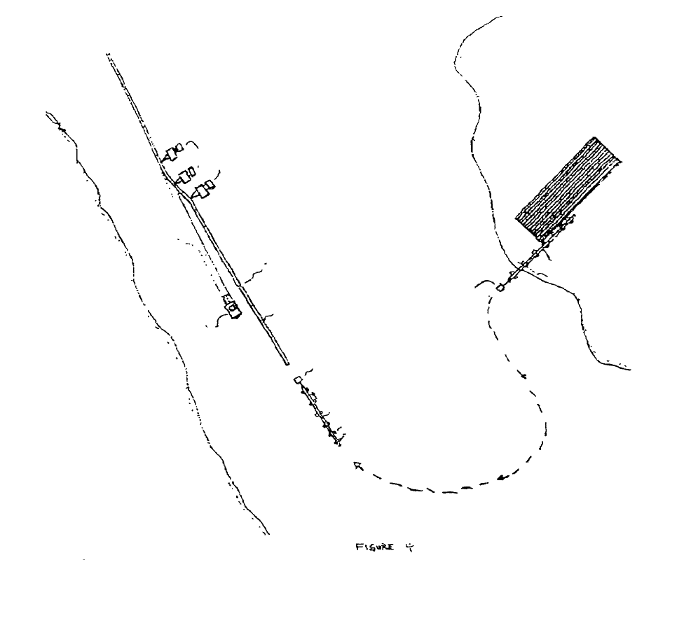

In preparation for pipelining activities as shown in FIG. 4, long longitudinal sections of pipeline are prefabricated at an onshore lay down area prior to the winter construction season. These sections which can be as long as one mile, will be welded, coated and pretested in the lay down area. When the sections are required for installations, they will be loaded onto sleigh trains and towed to the side of the ditch. There they will be welded to other sections to form the continuous pipeline. Subsequent lowering-in and backfill operations will complete pipeline installation activities.

In accordance with the present invention, it reliably and inexpensively prepares a pipeline workway for northern offshore projects. Also, the inventive method has no impact to the summer activities of fish, migrating mammals and nesting birds. Finally, it eliminates unfrozen excavation in the sea bottom which eliminates environmental impacts from silt migration. A further advantage of the invention is that the pipeline will be positioned in shallow waters which will allow relatively good access for maintenance and emergency repair activities.

It will be understood that each of the elements described above, or two or more together, may also find a useful application in other types of methods and constructions differing from the types described above.

While the invention has been illustrated and described as embodied in a method of constructing pipelines in shallow ice covered waters, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of constructing pipelines in shallow ice covered waters comprising the steps of freezing a long narrow pipeline workway so as to thicken ice until an ice mass grounds to an ocean floor; and removing ice in the ice mass to create a construction work area for laying a pipeline.

2. A method as defined in claim 1, wherein said freezing includes multiple flooding and freezing of a long narrow pipeline workway, to thicken the ice.

3. A method as defined in claim 1, wherein said removing includes forming a trench through the ice mass and downwardly below the ocean floor.

4. A method as defined in claim 1, wherein said removing includes forming a trench through the ice mass, so as to expose a region of a sea bottom in a region corresponding to the trench, freezing the thusly exposed region of the sea bottom, and forming a further ditch in the thusly frozen region of the sea bottom.

5. A method as defined in claim 1, wherein said removing includes forming a trench through the ice mass, freezing a region of a sea bottom by cooling pipes introduced through the trench, and forming a further ditch in the thusly frozen region of the sea bottom.

6. A method as defined in claim 3, wherein said laying of the pipeline includes fabricating continuous sections of the pipeline at an onshore area, towing the sections to a site of the trench; tying-in the sections to form a continuous pipeline, and lowering the thusly formed pipeline into the trench.
